(19) United States
(12) Patent Application Publication
(10) Pub. No.: US 2020/0307820 A1
(43) Pub. Date: Oct. 1, 2020

(54) PRESSURE-OPERATED CHECK VALVE

(71) Applicant: Parker-Hannifin Corporation, Cleveland, OH (US)

(72) Inventor: Don Ha, Long Beach, CA (US)

(21) Appl. No.: 16/813,129

(22) Filed: Mar. 9, 2020

Related U.S. Application Data
(60) Provisional application No. 62/825,041, filed on Mar. 28, 2019.
(60) Provisional application No. 62/879,608, filed on Jul. 29, 2019.

(51) Int. Cl. B64D 37/32; G05D 7/01; F16K 17/04; F16K 15/02

(52) U.S. Cl. CPC B64D 37/32; F16K 15/026; F16K 17/048; G05D 7/014

(57) ABSTRACT

A pressure-operated check valve assembly for a fuel tank inerting system includes a valve body having a fluid flow path between an inlet and an outlet, a plurality of poppets arranged in series in the fluid flow path, and an actuator in the valve body that is movable in response to fluid pressure in the valve body to actuate open the poppets or enable the poppets to close. Each poppet may be movable in the flow path independent of the other poppets to thereby provide independent and redundant functionality. The poppets may be normally biased toward closed, and activation of the actuator in response to fluid pressure being greater than a predefined threshold level may cause the actuator to overcome the biasing force of the poppets to urge the poppets to open. A flow restrictor downstream of the poppets may facilitate buildup of upstream pressure to enable low cracking pressure.

### RELATED APPLICATIONS

This application claims the benefit of U.S. Provisional Application No. 62/825,041 filed Mar. 28, 2019 and U.S. Provisional Application No. 62/879,608 filed Jul. 29, 2019, which are both hereby incorporated herein by reference in their entireties.

### TECHNICAL FIELD

The present invention relates generally to flow control technology, and more particularly to a valve such as for use in an aircraft fuel tank inerting system.

### BACKGROUND

Inerting systems are commonly used in aircraft applications to reduce the volatility of the ullage, or air volume above the liquid fuel, in an aircraft fuel tank. Conventional inerting systems include a fluid circuit that receives a flow of supply air, such as bleed air from the aircraft engine, and passes this air through an air separation module for separation into nitrogen-enriched air and oxygen-enriched air. The nitrogen-enriched air portion of the separated air is passed to the fuel tank to enhance the amount of inert air in the ullage.

Nitrogen-enriched air (NEA) distribution subsystems of such inerting systems typically utilize flow control devices such as check valves, which serve as reverse flow barriers to isolate the fuel tank inerting system from the fuel source during periods of non-operation. Conventional NEA subsystems typically use multiple such check valves in series for redundant performance.

### SUMMARY

Conventional check valves used in NEA distribution subsystems can often exhibit dynamic instability and produce chatter and/or flutter while in operation. This is because a conventional check valve is representative of a simple spring-mass system having a high-mass, low-spring-rate, and low-damping. For example, to achieve low flow resistance, which is often desirable in an NEA distribution subsystem, conventional check valves usually are designed to have a spring with a low spring-rate and low pre-load. The moving mass of the check element generally must maintain minimum dimensions to meet the flow and pressure characteristics required by the application. In addition, the gas medium in which the check valve operates typically offers little to no damping effect. Other than a very small amount of friction generated in the hinge or slide mechanism of a conventional check valve, there is very little damping provided. Therefore, as a spring-mass system which is inherently unstable, a conventional check element can easily begin to oscillate when triggered by a sudden change in flow or pressure, or by an external shock or vibration. Such oscillations of the check element may cause it to impact the valve seat and/or the full-open-stop with significant force to generate audible noise. A valve chatter can often be heard loudly and may be disturbing to those persons nearby. More significantly, however, such mechanical instability may impart damaging forces on the check valve components and may be a sign of an impending failure of the valve.

Conventional NEA distribution subsystems typically use multiple separate check valves as redundant reverse flow barriers. However, additional check valves in the system will degrade flow performance as they will increase the overall flow resistance in the distribution system. In addition, having multiple separate check valves installed in series can exacerbate the problem of instability because any perturbance in flow or pressure created by one check valve may influence the unstable operation of the other check valve(s), and the perturbance thus created by the second check valve can back-influence the first check valve. This can result in the multiple check valves cross-affecting each other and perpetuating flow instability in the system. A flow perturbance in an NEA flow stream is undesirable because it could make it more difficult to maintain a properly proportioned flow through various branches in the NEA flow distribution subsystem.

An aspect of the present disclosure provides a valve that improves upon one or more deficiencies of conventional check valves, such for use in NEA distribution subsystems.

For example, according to one aspect of the present disclosure, an exemplary valve is described herein that includes a pressure-operated actuator that responds to fluid pressure in the valve to actuate open one or more valve members in the valve to thereby allow flow through the valve, or in which the actuator responds to fluid pressure in the valve to enable the one or more valve members to close the fluid flow path through the valve.

More particularly, the valve may be configured such that the pressure-operated actuator activates in response to a pressure level in the valve that is greater than a threshold pressure level to thereby actuate open a plurality of serially-arranged valve members and allow flow, and the serially-arranged valve members may be normally biased toward their closed positions such that, when the pressure level in the valve is below the threshold value, the actuator is deactivated to allow the respective valve members to bias toward closed, thereby providing a multi-redundant reverse flow barrier in a single valve.

The valve may use a piston that is slidably movable in a bore of the valve as the pressure-operated actuator to actuate open and firmly hold open all valve members within the valve whenever the upstream valve pressure (e.g., manifold or system pressure) is at or above the minimum threshold level. A flow restriction orifice may be provided at a downstream portion of the valve that is sized to cause a desired buildup of upstream valve pressure that causes the actuator (e.g., piston) to actuate at a desired pressure level. The actuator (e.g., piston) may have a relatively high surface area on its upstream (inlet) side, which enables the actuator to generate a greater force to hold open the valve members at a relatively low cracking pressure, thereby reducing pressure drop and improving system operation.

The valve may reduce and/or be generally impervious to the effects of fluid flow perturbance. For example, so long as there is a minimum required manifold pressure, the valve may remain fully open and operate without chatter, flutter, or any other mechanical characteristics of dynamic instability. The valve also can provide a dynamically stable check valve that limits the causation of, or susceptibility to, perturbance in fluid flow.

The valve disclosed herein also can provide a check valve having a plurality of independently operating valve members (e.g., check elements) serially disposed internally thereof for significantly improving the performance and reliability of preventing reverse flow. The valve also may provide such valve members that can significantly reduce pressure drop across each valve member, therefore providing a valve that minimizes undue flow resistance.

In exemplary embodiments, the valve may employ a serially-nested-poppet concept that allows the plurality of valve members (e.g., poppet check elements) to be packaged into a small space. Such a check valve may provide similar or equivalent functionality to multiple separate conventional check valves, but in a lighter-weight and smaller-size package, and at a lower cost as compared with the combination of multiple separate conventional check valves.

In other exemplary embodiments, the valve may employ an axially spaced apart serial-poppet concept, which other than being a relatively longer valve than conventional designs, may enable ease of retrofitting into existing fuel tank inerting system circuits, such as by virtue of similar inlet and outlet connections as the conventional designs, but with fewer parts and lower cost than a combination of multiple separate conventional check valves.

According to an aspect of the present disclosure, a valve assembly includes: a valve body extending along a longitudinal axis, the valve body having an inlet, an outlet, and a fluid flow path fluidly connecting the inlet and outlet; a plurality of valve members arranged in series in the fluid flow path along the longitudinal axis, each of the plurality of valve members being axially movable within the fluid flow path between a respective open position in which the fluid flow path from the inlet to the outlet is open by the respective valve member, and a respective closed position in which the fluid flow path from the inlet to the outlet is closed by the respective valve member; and an actuator movable in a direction of the longitudinal axis in response to a fluid pressure level in the valve body; wherein activation of the actuator in response to the fluid pressure level causes the actuator to move the respective valve members to their respective open positions to thereby open the fluid flow path through the valve body; and wherein deactivation of the actuator in response to the fluid pressure level enables the respective valve members to move to their respective closed positions to thereby close the fluid flow path through the valve body.

According to another aspect of the present disclosure, a pressure-operated check valve assembly, includes: a valve housing having an inlet, an outlet, and a fluid flow path fluidly connecting the inlet and the outlet; a spring-loaded poppet in the valve housing arranged downstream of a valve seat portion in the fluid flow path, the spring-loaded poppet being independently movable along a longitudinal axis of the check valve assembly; a piston assembly slidably movable in the valve housing in a direction of the longitudinal axis, the piston assembly having a face exposed to upstream fluid pressure in an upstream chamber of the valve housing that is upstream of the valve seat portion; and a flow restrictor downstream of the valve seat portion; wherein the spring-loaded poppet includes a poppet that is biased by a poppet spring toward the valve seat portion; wherein, when a fluid pressure level in the upstream chamber of the valve housing is greater than a predefined threshold pressure level, the piston assembly moves in a direction toward the outlet thereby unseating the spring-loaded poppet from the valve seat portion and opening the fluid flow path between the inlet and the outlet; wherein, when the fluid pressure level in the upstream chamber of the valve housing is below the predefined threshold pressure level, the piston assembly moves in a direction toward the inlet and the spring-loaded poppet is seated against the valve seat portion thereby closing the fluid flow path between the inlet and the outlet; and wherein the predefined threshold pressure level is set at least in part by the biasing force provided by the poppet spring.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a schematic fluid circuit diagram of a conventional fuel tank inerting system having a conventional NEA distribution subsystem.

FIG. 2 is a schematic fluid circuit diagram of another conventional fuel tank inerting system having a conventional NEA distribution subsystem.

FIG. 3 is a schematic fluid circuit diagram of a fuel tank inerting system with an NEA distribution subsystem having an exemplary valve assembly according to an embodiment of the present disclosure.

FIG. 4 is a schematic fluid circuit diagram of a fuel tank inerting system with an NEA distribution subsystem having an exemplary valve assembly according to another embodiment of the present disclosure.

FIG. 5 is a side view of an exemplary valve assembly according to an embodiment of the present disclosure.

FIG. 6 is an inlet side front view of the valve assembly in FIG. 5.

FIG. 7 is an outlet side rear view of the valve assembly in FIG. 5.

FIG. 8 is a cross-sectional side view of the valve assembly taken about the line A-A in FIG. 7, in which the valve assembly is shown in an exemplary open state.

FIG. 9 is a cross-sectional side view of the valve assembly taken about the line A-A in FIG. 7, in which the valve assembly is shown in an exemplary closed state.

FIG. 10 is a cross-sectional side view of the valve assembly in FIG. 5, in which a first valve member is shown as inoperable.

FIG. 11 is a cross-sectional side view of the valve assembly in FIG. 5, in which a second valve member is shown as inoperable.

FIG. 12 is a cross-sectional side view of the valve assembly in FIG. 5, in which a third valve member is shown as inoperable.

FIG. 13 is a cross-sectional side view of another exemplary valve assembly according to an embodiment of the present disclosure, in which the valve assembly is shown in an exemplary open state.

FIG. 14 is a cross-sectional side view of the valve assembly in FIG. 13 shown in an exemplary closed state.

### DETAILED DESCRIPTION

The principles and aspects of the present invention have particular application to check valves for fuel tank inerting systems, or nitrogen-enriched air (NEA) distribution subsystems, and thus will be described below chiefly in this context. It is understood, however, that the principles and aspects of the present invention may be applicable to other fluid systems or for other types of valves where desirable for a particular application.

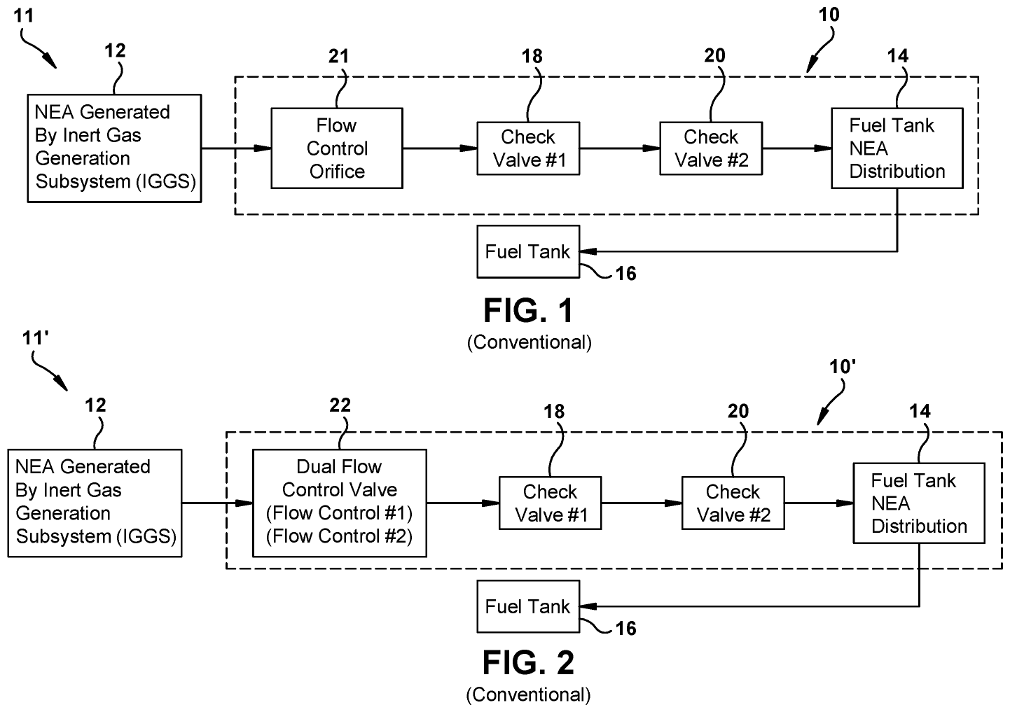

Referring to FIGS. 1 and 2, conventional NEA distribution subsystems 10, 10′ of respective fuel tank inerting systems 11, 11′ are shown. Generally, the NEA distribution subsystems 10, 10′ receive an inert gas (e.g., nitrogen) that is generated by an Inert Gas Generation Subsystem (IGGS) 12. The IGGS 12 will include an NEA generator, such as an air separation module (ASM). The NEA distribution subsystems 10, 10′ may include in-tank distribution components 14, such as inter-branch flow-balancing restrictors, isolation valves, conduits, or the like, in addition to the check valves 18, 20 of the main distribution line external to the fuel tank, for feeding the inert gas (nitrogen-enriched air) to the ullage of the fuel tank 16. Generally, such NEA distribution subsystems 10, 10′ include multiple check valves 18, 20 in the main distribution line leading to the fuel tank, which serve as reverse flow barriers to isolate portions of the fuel tank inerting system from the fuel source 16 during periods of non-operation.

FIG. 1 shows the subsystem 10 having a single flowrate mode via a single flow control orifice 21, and with dual reverse flow check functions via conventional check valves 18 and 20. FIG. 2 shows the system 10′ having dual flowrate modes as provided by two fixed orifices which are individually selectable by the operation of a dual flow control valve 22. The system 10′ also provides dual reverse flow check functionality via conventional check valves 18 and 20.

Generally, such conventional check valves 18, 20 have either a flapper or a poppet check element. A flapper check element is hinged at one end and can swing open when there is a pressure difference created across the flapper due to fluid flow. The flapper check element otherwise remains in a spring-loaded normally closed position when there is no fluid flow. Similarly, a poppet check element typically is spring-loaded to a normally closed position when there is no flow. However, when there is fluid flow, a pressure difference created across the poppet causes the poppet to push open against the spring force. Such conventional check valves based on these designs are well-known in the art, and as such their operating principles herein need not be discussed in any greater detail.

One problem with such conventional check valves 18, 20 flowing gaseous media (NEA, for example) is that they very often exhibit dynamic instability. This is because such conventional check valves represent a simple spring-mass system having a high-mass, low-spring-rate and low-damping. For example, to achieve a low flow resistance (which is often desirable in a flow distribution system), a conventional check valve usually is designed to have a spring with a low spring-rate and low pre-load. The moving mass of the conventional check element generally must maintain certain minimum dimensions to meet the flow and pressure characteristics required by the application. In addition, the gas medium offers little to no damping, and other than a very small amount of friction generated in the hinge or the slide mechanism of the check element, the components of the check valve also provide little to no damping effect. Therefore, as a spring-mass system which is inherently unstable, a conventional check element can easily begin to oscillate when triggered by a sudden change in flow or pressure, or by an external shock or vibration.

An advanced state of dynamical instability can cause conventional check valves 18, 20 to chatter and/or flutter. These are symptoms which typically are created by the check element violently oscillating and impacting the valve seat and/or the full-open-stop on opposite sides with significant force to generate audible noise. A valve chatter can often be heard loudly and can be disturbing to an airline passenger sitting nearby. More significantly, however, such mechanical instability may impart damaging forces on the check valve components and may be a sign of an impending failure.

Having multiple conventional check valves 18, 20 installed in series can exacerbate the problem of instability because any perturbance in flow or pressure created by one check valve is likely to influence unstable operation of the other check valve(s). In addition, the perturbance thus created by the second check valve is likely to back-influence the first check valve. This results in the multiple check valves cross-affecting each other and perpetuating the flow instability in the system. A flow perturbance in an NEA flow stream is undesirable because it could make it more difficult to maintain a properly proportioned flow through various branches in the NEA flow distribution subsystem.

Generally, conventional check valves 18, 20 must create and maintain a flow resistance to operate. Such a check valve therefore relies on the pressure drop created across the check element to crack open the valve and maintain this open state during flow. A higher flow resistance will generate a greater force to hold open the check element and will thus assist in better controlling the dynamic instability. However, a higher flow resistance will generate greater pressure loss in the system which is almost always undesirable. Using more check valves (therefore more reverse flow barriers) in an NEA distribution subsystem will assist in better isolating the portions of the inerting system from the fuel source during periods of non-operation; however, more check valves will typically degrade the flow performance as they will increase the overall flow resistance in the distribution system as well as exacerbate any problem of dynamic instability.

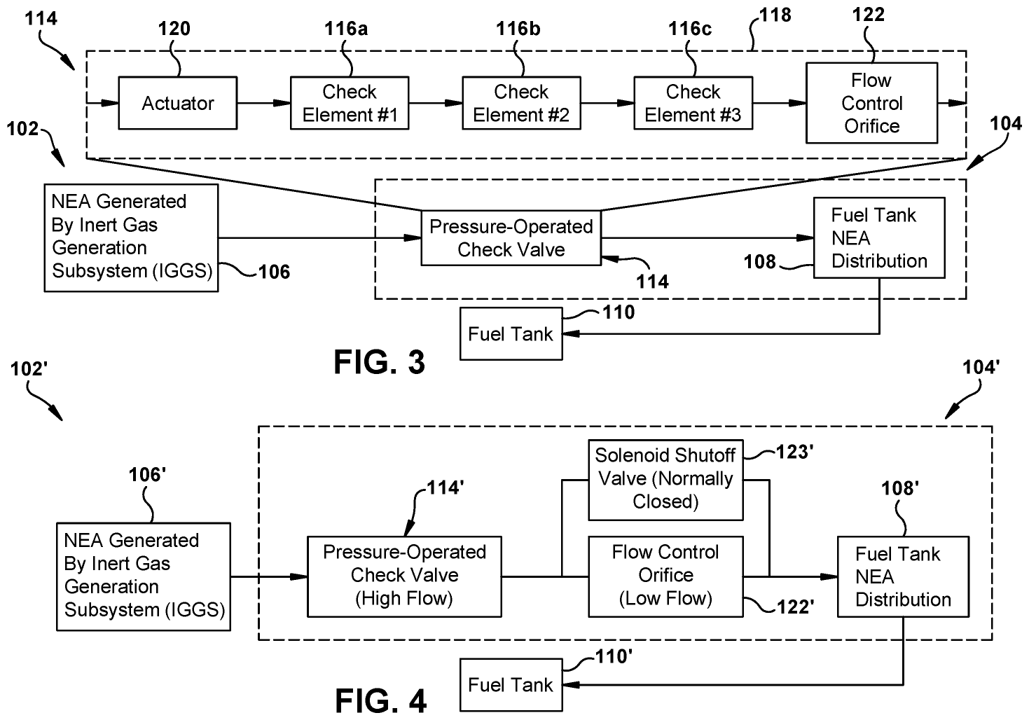

Turning to FIG. 3, shown is a schematic fluid circuit diagram of a fuel tank inerting system 102 with an NEA distribution subsystem 104 having an exemplary valve assembly 114 according to an embodiment of the present disclosure. Generally, the NEA distribution subsystem 104 operates similarly to the subsystems 10, 10′ described above, and may include in-tank distribution components 108, such as inter-branch flow-balancing restrictors, isolation valves, conduits or the like in addition to the check valve 114 of the main distribution line external to the fuel tank, for feeding inert gas (nitrogen-enriched air) to the ullage of the fuel tank 110.

As shown in the detailed schematic section in FIG. 3, in exemplary embodiments the valve assembly 114 is a pressure-operated check valve (“POCV”) having a plurality of serially arranged valve members 116a, 116b, 116c (e.g., check elements) in a fluid flow path of a valve body 118 of the valve 114.

As shown, the pressure-operated valve assembly 114 (also referred to simply as valve 114) may include an actuator 120 that is operable to move the valve members (collectively referred to with reference numeral 116) to enable opening or closing the valve 114, as described in further detail below. In the illustrated embodiment, the valve 114 also includes a flow control orifice, or flow restrictor 122, which is sized to achieve a desired amount of flow in the NEA distribution line while the inerting system is in operation. As discussed below, the flow restrictor 122 also enables a system fluid pressure (e.g., manifold pressure) to build-up and be maintained inside the valve body 118, which in exemplary embodiments causes the actuator 120 to activate or deactivate at desired pressure level(s) to enable opening or closing of the valve 114.

As shown in the illustrated schematic, for example, the flow restrictor 122 is positioned within the valve body 118 downstream of the valve members 116, and the actuator 120 is positioned within the valve body 118 upstream of the valve members 116. The positioning of the flow restrictor 122 downstream enables fluid pressure to build at the upstream (inlet) portion containing the actuator 120 when there is sufficient flow through the valve 114. In exemplary embodiments, the pressure-operated actuator 120 is configured to activate in response to the upstream (inlet) pressure level in the valve body 118 being greater than a threshold pressure level to thereby actuate open the plurality of serial valve members 116 and allow flow through the valve 114. The serially arranged valve members 116 may be normally biased toward their closed positions such that, when the pressure level in the valve body 118 is below the threshold value, the actuator 120 is configured to deactivate and allow the valve members 116 to bias toward closed.

By positioning the flow restrictor 122 at a downstream portion and the pressure-operated actuator 120 at the upstream portion of the valve, the valve 114 may be configured to actuate open and firmly hold open all valve members 116 within the valve 114 whenever the upstream valve pressure is at or above the minimum threshold level (e.g., when manifold or system pressure is present and providing sufficient flow). On the other hand, when the system or manifold pressure drops below the threshold value (e.g., low or no flow), then the valve 114 is configured to close. This enables the valve 114 to serve as a check valve with multiple-redundant reverse flow barrier functionality via the valve members 116 to isolate portions of the fuel tank inerting system 102 from the fuel source 110 during periods of non-operation.

Advantageously, the exemplary system 104 with the exemplary valve 114 shown in FIG. 3 may provide similar functionality as the conventional system 10 shown in FIG. 1, but with fewer components and with improved dynamic stability to mitigate chatter and/or flutter which is a problem with conventional check valves 18, 20. In the illustrated embodiment, the valve 114 provides a triple-redundant reverse flow barrier via the valve members 116 in a single valve 114, and thus provides one additional layer of reverse flow protection over the conventional system shown in FIG. 1.

Referring to FIG. 4, another exemplary schematic fluid circuit diagram of a fuel tank inerting system 102′ with an NEA distribution subsystem 104′ having an exemplary valve 114′ according to an embodiment of the present disclosure is shown. The valve 114′ is to the same as the valve 114 in FIG. 3, however there is an additional flow control orifice, or flow restrictor 122′, located downstream of the valve 114′. The additional flow restrictor 122′ cooperates with a solenoid shutout valve 123′ to provide low flow or high flow functionality for the valve 114′. In this manner, the system 102′ provides similar or equivalent functionality to the system 11′ in FIG. 2, with selective dual-flowrate modes and redundant reverse flow barrier functionality. In the illustrated embodiment, for example, the pressure-operated check valve 114′ is equipped with an outlet orifice providing high flowrate and the external orifice 122′ provides low flowrate. A low flowrate mode is selected when the solenoid shutoff valve 123′ de-energizes closed and the external orifice 122′ becomes the controlling restriction. A high flowrate mode is selected when the solenoid shutoff valve 123′ energizes open and allows the flow to bypass the external orifice 122′, thus enabling the high flow orifice to become the controlling restriction.

As discussed in further detail below, the configuration of the flow restrictor 122, 122′ and actuator 120 may further enhance the functionality of the valve 114, 114′ by enabling the valve members 116 to hold fully open at a relatively low pressure, thereby reducing pressure drop and improving system operation. Generally, the exemplary valve(s) 114, 114′ may reduce and be generally impervious to the effects of fluid flow perturbance which is a problem with conventional check valves. For example, so long as there is a minimum required manifold pressure, the valve 114, 114′ may remain fully open and generally operate without chatter, flutter, or any other mechanical characteristics of dynamic instability. The valve 114, 114′ also provides a plurality of independently operating valve members 116a, 116b, 116c (e.g., check elements) serially disposed internally thereof for significantly improving the performance and reliability of preventing reverse flow. The valve 114, 114′ also may provide such valve members 116 that can significantly reduce pressure drop across each valve member, therefore providing a valve that minimizes undue flow resistance. Such a valve 114, 114′ also may provide significant size and weight savings by replacing the collective group of existing check valves (e.g., 18 and 20) and providing similar functionality with the single valve 114, 114′.

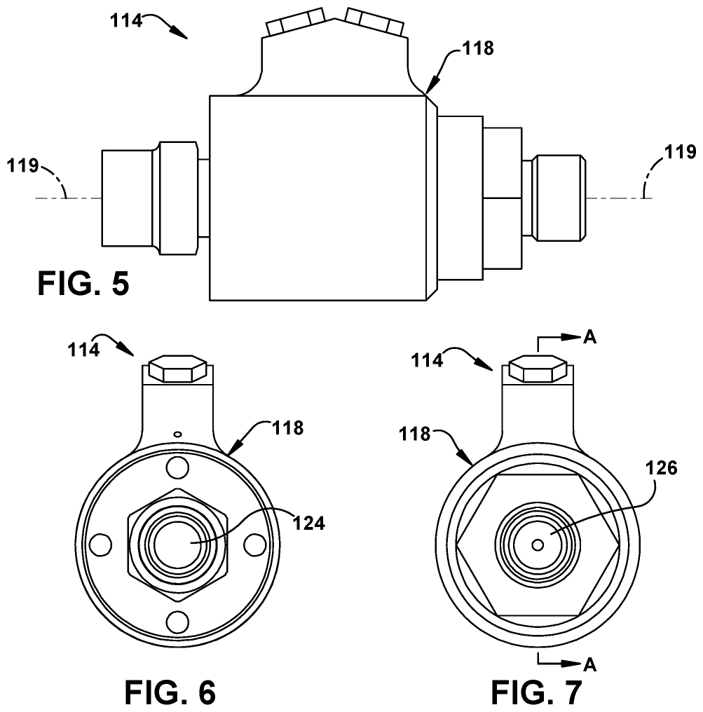

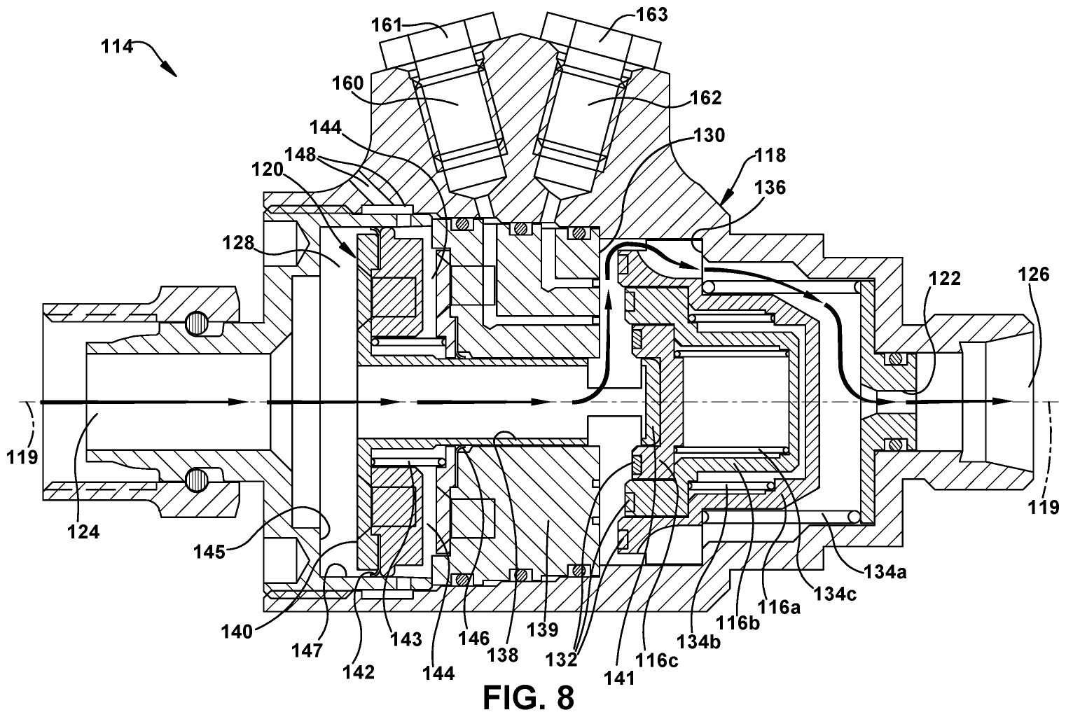

FIGS. 5-9 illustrate in further detail an exemplary embodiment of the valve assembly 114 that is shown schematically in FIG. 3. As shown, the valve assembly 114 (also referred to as valve 114) includes valve body 118, which may be formed as a generally cylindrical housing that extends along a longitudinal axis 119. The valve body 118 generally includes an inlet 124 (e.g., inlet port and inlet passage), an outlet 126 (e.g., outlet port and outlet passage), and an internal chamber 128 that together with other components of the valve 114 form a fluid flow path (shown with directional flow arrows in FIG. 8) that fluidly connects the inlet 124 and outlet 126.

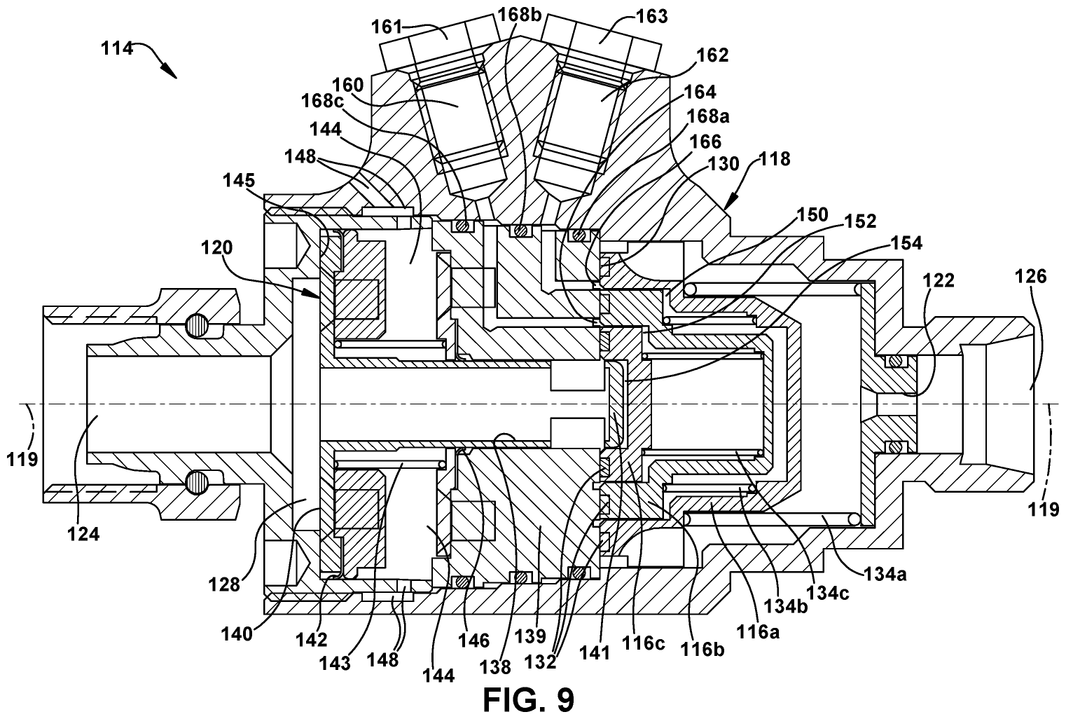

Referring particularly to FIGS. 8 and 9, shown are cross-sectional views of the exemplary valve 114 in an exemplary open state (FIG. 8) and an exemplary closed state (FIG. 9). As shown, the valve 114 includes a plurality of valve members 116a, 116b, 116c that are arranged in series in the fluid flow path along the longitudinal axis 119. In exemplary embodiments, each of the valve members (collectively referred to with reference numeral 116) have individual freedom of movement along the longitudinal axis 119 between a respective first position (FIG. 8), in which the fluid flow path from the inlet 124 to the outlet 126 is open by the respective valve members 116; and a respective second position (FIG. 9), in which the fluid flow path from the inlet 124 to the outlet 126 is closed by the respective valve members 116. As shown, the valve 114 includes actuator 120, which is movable in a direction of the longitudinal axis 119 in response to fluid pressure in the valve body 118. As described in further detail below, the actuator 120 may activate in response to fluid pressure in the valve body 118 being above a threshold value, which such activation may cause the actuator 120 to commonly move the respective valve members 116 (directly or indirectly) to their respective open positions to open the flow path (FIG. 8). On the other hand, when the pressure level in the valve body 118 is below the threshold value, the actuator 120 may be configured to deactivate and enable the respective valve members 116 to move to their respective closed positions to close the flow path (FIG. 9).

In exemplary embodiments, each of the valve members 116a, 116b, 116c is configured as a poppet (also referred to with reference numeral 116). In the illustrated embodiment, the poppets 116 are serially nested within one another, with a second poppet 116b nested within a larger first poppet 116a, and a smaller third poppet 116c nested within the second poppet 116b. As shown, a valve seat 130 is formed inside of the internal chamber 128 which cooperates with respective sealing surfaces 132 (e.g., seals) of each of the poppets 116 to enable opening or closing of the fluid flow path across the valve seat 130. In the illustrated embodiment, the poppets 116 are located on a downstream side of the valve seat 130, and are nested in such a way that the respective sealing surfaces 132 of the poppets 116 are axially aligned with each other when sealingly engaging respective portions of the valve seat 130.

As shown, the poppets 116a, 116b, 116c each include a corresponding biasing member 134a, 134b, 134c (e.g., springs) that independently bias each respective poppet toward the valve seat 130. In the illustrated embodiment, for example, the first biasing member 134a of the first poppet 116a engages a radially outer shoulder of the poppet 116a and an internal end portion of the valve body 118. The second biasing member 134b of the second poppet 116b is internal of the first poppet 116a and engages an outer shoulder of the second poppet 116b and an internal shoulder of the first poppet 116a. The third biasing member 134c of the third poppet 116c is internal of the second poppet 116b and engages an outer shoulder of the third poppet 116c and an internal shoulder of the second poppet 116b.

The valve assembly 114 also includes respective stops that restrict movement of the respective poppets 116 toward the outlet 126. In the illustrated embodiment, for example, the movement of the first poppet 116a toward the outlet 126 is restricted by a stop surface 136 formed by an internal shoulder of the valve body 118. The second poppet 116b is restricted by the prevailing position of the first poppet 116a via engagement of respective shoulders of the poppets 116a, 116b (as shown in FIG. 8). Also as shown, the third poppet 116c is restricted by the prevailing position of the second poppet 116b via engagement of respective shoulders of the poppets 116b, 116c.

In exemplary embodiments, the actuator 120 is configured as a piston assembly 120 that is predominantly positioned in an upstream (inlet) side of the internal chamber 128. In the illustrated embodiment, the piston assembly 120 includes a hollow shaft portion 138 and a piston portion 140. As shown, the hollow shaft portion 138 is adapted to operate slidably inside a center bore of an insert 139 that forms the valve seat 130. The hollow shaft portion 138 has openings on its upstream and downstream sides, and thus forms a portion of the fluid flow path that fluidly connects the upstream portion of the chamber 128 with the downstream portion of the chamber 128 across the valve seat 130 (as shown with the directional flow lines in FIG. 8, for example).

The piston portion 140 of the piston assembly 120 is located upstream of the valve seat 130 and the poppets 116, and downstream of the inlet 124. As shown, the piston portion 140 of the piston assembly 120 is adapted to operate inside the upstream (inlet) portion of the internal chamber 128 and slidably moves in the axial direction between first (FIG. 8) and second (FIG. 9) positions. As shown in FIG. 9, the piston assembly 120 may be biased toward the inlet 124 (i.e., closed position) via a biasing member 143 (e.g., piston spring). In the illustrated embodiment, the piston assembly 120 is restricted in its movement toward the inlet 124 by a stop surface 145. As shown in FIG. 8, a downstream end portion 141 of the hollow shaft portion 138 is configured to engage the first poppet 116a and urge the poppets 116 toward open when the actuator 120 is activated, as described in further detail below. The piston assembly 120 may be restricted in its movement toward the outlet 126 by the prevailing position of the poppet(s) 116 and the stop surface 136.

In exemplary embodiments, the piston portion 140 may include a low-friction seal 142 that slidingly engages an internal bore surface 147. As shown, the internal bore surface 147 may be formed by an inlet insert that is threadably coupled to a main portion of the valve body 118. The seal 142 sealingly maintains contact with the internal bore surface 147 as the piston assembly 120 moves to form a pressure barrier between the upstream (inlet) portion of the chamber 128 on one side of the piston portion 140 and an ambient pressure cavity 144 on the opposite side of the piston portion 140. The hollow shaft portion 138 also may have a low-friction seal 146 that form a pressure barrier between the chamber 128 and cavity 144. As shown, the ambient pressure cavity 144 is in fluid communication with the ambient environment surrounding the valve assembly 114 via vent fluid passage(s) 148 provided in the valve body 118. As described in further detail below, the pressure differential between the fluid pressure in the upstream portion of chamber 128 and the ambient pressure in ambient cavity 144 provides a motive force to activate the actuator 120 and thereby actuate open the poppets 116 when the valve 114 is in operation.

As shown, in exemplary embodiments the valve assembly 114 also includes flow control orifice 122 (also referred to as flow restrictor 122) downstream of the poppets 116 and upstream of the outlet 126. In the illustrated embodiment, the flow restrictor 122 is provided as an insert that is positioned at a downstream outlet end portion of the valve body 118. As described above in connection with FIG. 3, the flow restrictor 122 generally is sized to achieve a desired amount of flow in the NEA distribution line while the inerting system is in operation. The flow restrictor 122 also is sized to enable the fluid pressure to build-up and be maintained inside the upstream (inlet) portion of the chamber 128 in the valve assembly 114. In the illustrated embodiment, for example, the orifice 122 has a size that is much smaller than the size of the inlet 124 passage and the internal passage formed by the hollow shaft portion 138. As described below, such flow restriction provided by the flow restriction orifice 122 facilitates the actuator 120 (e.g., piston assembly 120) to activate in response to a certain level of fluid pressure buildup at the upstream (inlet) portion of the chamber 128, thereby enable opening of the valve 114 at relatively low cracking pressures when sufficient system or manifold pressure is present, for example.

In alternative embodiments, the flow restrictor 122 may be removed from the valve body 118 and be physically relocated to an external location downstream of the valve assembly 114. Similarly, as described above, the valve 114 may be used as valve 114′ in the system 104′ of FIG. 4, wherein the restrictor 122 of the valve 114′ may be relocated to an external location downstream of the valve assembly 114′ to cooperate with an additional downstream external orifice 122′ and solenoid shutoff valve 123′ to provide the NEA distribution subsystem with low and high flowrate functionality. Arranged in these manners, the pressure-operated check valve 114, 114′ will become application-neutral wherein the same configuration of the valve may be used in various inerting systems requiring different NEA flow rates. Furthermore, it is understood that such an externally located flow restrictor 122 may be integrated with the additional external orifice 122′ and solenoid shutoff valve 123′ into one valve assembly. Such valve assembly will provide a dual flow control functionality similar to the dual flow control valve 22 of FIG. 2.

Still referring to FIGS. 8 and 9, an exemplary operation of the valve assembly 114 will now be described in further detail. Referring to the exemplary open state of FIG. 8, and as mentioned above, a motive force that causes the actuator 120 to activate and drive the respective poppets 116 to open is generated by a pressure differential across the piston portion 140 between the fluid pressure in the upstream portion of chamber 128 and the ambient pressure in ambient cavity 144 when the valve 114 is in operation. For example, when the actuator 120 (e.g., piston assembly 120) is activated in response to fluid pressure in the upstream (inlet) side of the chamber 128 being greater than a predefined threshold pressure level, then the actuator 120 is activated to drive the poppets 116 to their fully open position against their respective stops. For example, as shown in FIG. 8, the downstream end portion 141 of the piston assembly 120 drives the third poppet 116c to engage the second poppet 116b, which in turn drives the first poppet 116a to engage the stop surface 136. As shown, the open state creates an open flow path through the valve that allows the fluid (e.g., NEA) to flow from the inlet 124 to the outlet 126.

The predefined pressure threshold for activating the actuator 120 may be set, at least in part, by the biasing forces provided by the respective poppet biasing members 134a, 134b, 134c (collectively 134) which urge the poppets 116 toward closed, and the biasing force provided by the piston biasing member 143 that biases the piston assembly 120 towards closed. When the inlet manifold pressure is at or above the predefined threshold level, the actuator (e.g., piston assembly 120) generates a sufficient force to overcome the biasing forces of the various biasing members 134, 143 and drive the poppets 116 toward their fully open positions, as shown in FIG. 8.

As discussed above, the flow restrictor 122 provided at the downstream portion of the valve 114 restricts fluid flow and facilitates a build-up and maintenance of the pressure in the upstream (inlet) portion of the chamber 128 for causing activation of the actuator 120. In the illustrated embodiment, the piston portion 140 of the actuator 120 has a face with a relatively large surface area at its upstream (inlet) side, which enables the actuator 120 to generate a greater force in response to the upstream pressure to hold open the poppets 116. In this manner, the cooperation of the downstream flow restrictor 122 with the relatively large surface area provided by the upstream face of the piston assembly 120 enables the valve assembly 114 to open at a relatively low cracking pressure, thereby reducing pressure drop and improving system operation. In exemplary embodiments, for example, the maximum threshold pressure required to fully open the valve 114 is approximately 3 psig. This threshold pressure level can easily be adjusted up or down by proportionately varying the biasing force(s) of one or more of the biasing member(s) 134, 143.

Referring to the exemplary closed state of FIG. 9, when the pressure level in the inlet portion of the chamber 128 upstream of the piston portion 140 is below the predefined threshold pressure level, the serially arranged poppets 116 are biased toward closed. In this state, the biasing forces provided by the biasing members 134, 143 are greater than the force provided by the piston assembly 120 by virtue of the upstream (inlet) pressure being below the threshold value. For example, such a closed or shutoff state may be achieved when the system or manifold pressure is reduced, or when the system is non-operational such that there is no fluid flow through the system. As shown in the illustrated state, the piston assembly 120 is shown biased by the piston spring 143 to its fully retracted position against the stop 145. In addition, each of the respective poppets 116a, 116b, 116c are biased by their respective biasing members 134a, 134b, 134c to sealingly engage respective portions of the valve seat 130 and thus close respective portions of the flow path. In the illustrated embodiment, the biasing members 134a, 134b, 134c are configured to provide incrementally greater biasing forces such that the first biasing member 134a can overcome the combined opposing forces by the second and third biasing members 134b, 134c and drive the first poppet 116a to close; or the second biasing member 134b can overcome the opposing force by the third biasing member 134c and drive the second poppet 116b to close; and so on.

In exemplary embodiments, the actuator 120 (e.g., piston assembly 120) is discrete and independently movable relative to each valve member 116 (e.g., poppets 116), and each valve member 116a, 116b, 116c is discrete and independently movable relative to each other. As shown in FIG. 9, for example, a gap 150 is formed between the first and second poppets 116a, 116b; another gap 152 is formed between the second and third poppets 116b, 116c; and yet another gap 154 is formed between the third poppet 116c and the end portion 141 of the piston assembly 120. In this manner, the poppets 116 are physically isolated from one another, and from the piston assembly 120, and thus are able to function independently. This provides a triple-redundant reverse flow barrier functionality for the valve assembly 114, in which such reverse flow is defined as a direction of flow from the outlet 126 to the inlet 124.

Still referring to FIGS. 8 and 9, in exemplary embodiments, the valve assembly 114 may include test ports 160 and 162, which enable testing and verification of the independent and redundant functionality of the poppets 116a, 116b, 116c. As shown, the test port 160 is in fluid communication with an annular groove 164 formed in the insert 139 that forms the valve seat 130 to provide a test access point between the second poppet 116b and third poppet 116c. The test port 162 is in fluid communication with an annular groove 166 to provide a test access point between the first poppet 116a and second poppet 116b. As shown, when these test ports 160, 162 are not in use, they are closed with plugs 161, 163.

An exemplary operation of leak test verification of the reverse flow barrier components will now be described in further detail. To test the first reverse flow barrier components including the first poppet 116a and a first O-ring 168a, the test port 162 is opened to allow air to vent-in, and vacuum leak test equipment (e.g., vacuum pump) is connected to the outlet 126. In this test, it is immaterial whether the test port 160 and the inlet 124 are capped or not. Generally, any leakage detected at the outlet 126 confirms a leakage through either the first poppet 116a or the first O-ring 168a.

To test the second reverse flow barrier components including the second poppet 116b and a second O-ring 168b, the test port 160 is opened to allow air to vent-in and a vacuum leak test equipment is connected to the test port 162. The outlet 126 is capped to exclude the first reverse flow barrier components 116a, 168a from this test. In this test, it is immaterial whether the inlet 124 is capped or not. Any leakage detected at the test port 162 confirms a leakage through either the second poppet 116b or the second O-ring 168b.

To test the third reverse flow barrier components including the third poppet 116c and a third O-ring 168c, the inlet port 124 is opened to allow air to vent-in and a vacuum leak test equipment is connected to the test port 160. The outlet 126 is capped and the test port 162 is plugged to exclude the first and second reverse flow barrier components 116a, 168a, 116b, 168b from this test. Any leakage detected at the test port 160 confirms a leakage through either the third poppet 116c or the third O-ring 168c.

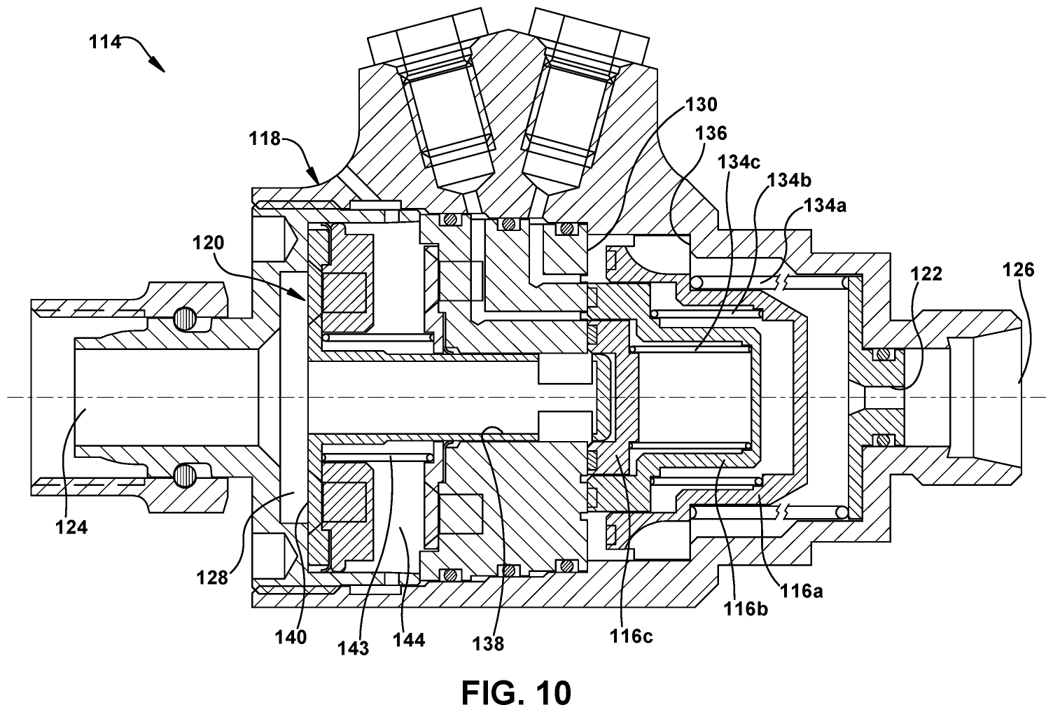

Referring now to FIGS. 10-12, shown are examples of operation of the valve assembly 114 when any of biasing members 134a, 134b, or 134c break or fail. Such failure mechanisms further illustrate the independent and redundant functionality of each poppet 116a, 116b, and 116c, in that, a failure of any poppet biasing member 134a, 134b, or 134c will cause a loss of function only of the poppet 116 associated with the failed biasing member 134, and will not cause the other poppets 116 from losing their functionality.

FIG. 10 shows that the first poppet spring 134a has broken resulting in the first poppet 116a becoming unseated from the valve seat 130. As shown, however, this does not cause the second and third poppets 116b, 116c from losing their preloads and they remain properly seated to sealingly engage the valve seat 130. As shown, the second poppet spring 134b has now extended a little more to push the first poppet 116a against the stop 136, however, this has not resulted in a significant reduction in preload because of the relatively low spring rate of the spring 134b.

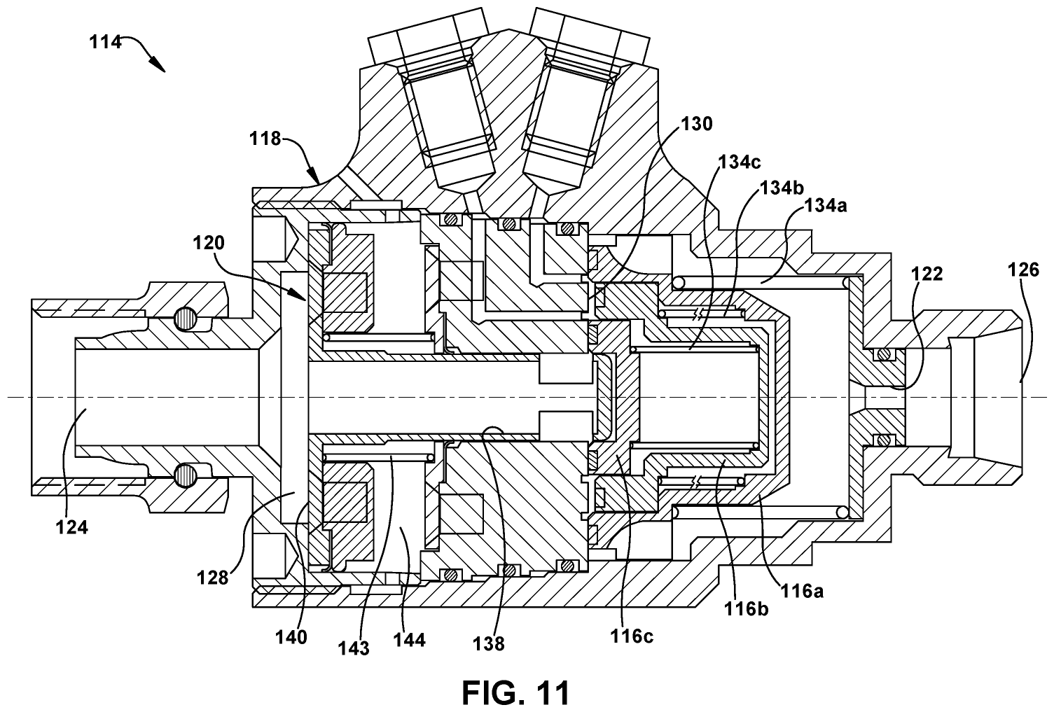

FIG. 11 shows the second poppet spring 134b has broken resulting in the second poppet 116b becoming unseated from the valve seat 130. As shown, however, this does not cause the first and third poppets 116a, 116c from losing their preloads and they remain properly seated to sealingly engage the valve seat 130. The third poppet spring 134c has now extended a little further to push the second poppet 116b against the first poppet 116a, however, this has not resulted in a significant reduction in preload because of low spring rate.

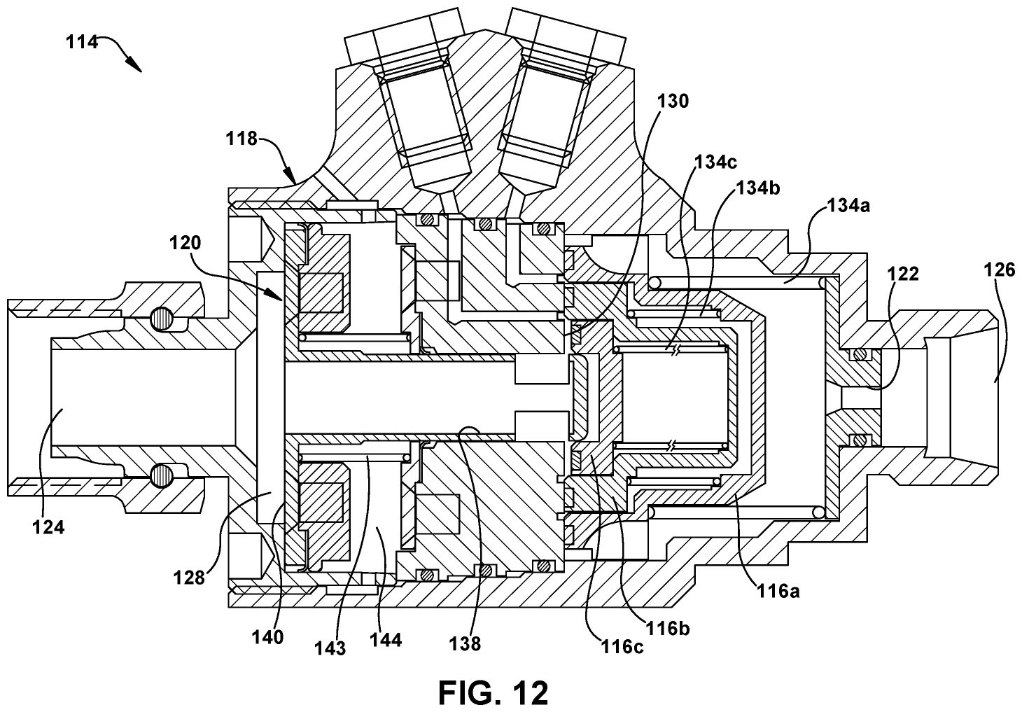

FIG. 12 shows the third poppet spring 134c has broken resulting in the third poppet 116c becoming unseated from the valve seat 130. As shown, however, this does not cause the first and second poppets 116a, 116b from losing their preloads and they remain properly seated against the valve seat 130 in a similar manner as described above.

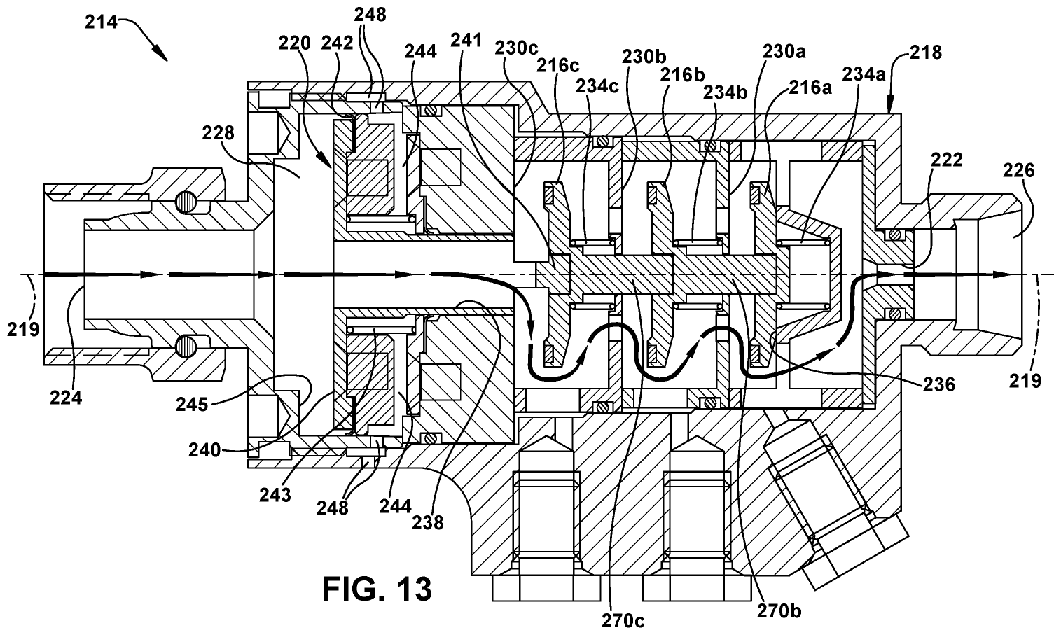

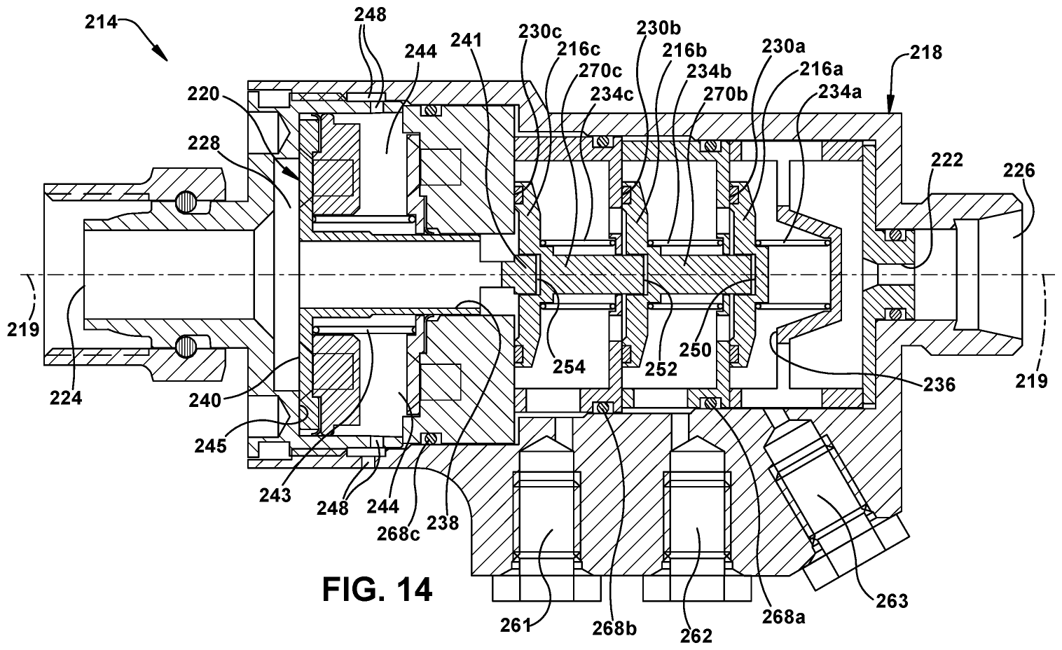

Turning now to FIGS. 13 and 14, another exemplary valve assembly 214 is shown according to an embodiment of the present disclosure. The valve assembly 214 is substantially similar to the above-referenced valve assembly 114, and consequently the same reference numerals but in the 200-series are used to denote structures corresponding to similar structures in the valve assemblies 114, 214. In addition, the foregoing description of the valve assembly 114 is equally applicable to the valve assembly 214, except as noted below. Moreover, aspects of the valve assemblies 114, 214 may be substituted for one another or used in conjunction with one another where applicable.

Similarly to the valve assembly 114, the valve assembly 214 (also referred to as valve 214) includes a valve body 218 that extends along a longitudinal axis 219. The valve body 218 generally includes an inlet 224 (e.g., inlet port and inlet passage), an outlet 226 (e.g., outlet port and outlet passage), and an internal chamber 228 that together with other components of the valve 214 form a fluid flow path (shown with directional flow arrows in FIG. 13) that fluidly connects the inlet 224 and outlet 226.

The valve assembly 214 differs from the valve assembly 114 in that a plurality of valve members 216a, 216b, 216c (e.g., poppets 216) are arranged in series in the fluid flow path in axially spaced apart relation along the longitudinal axis 219. As shown, the valve assembly 214 includes corresponding valve seats 230a, 230b, 230c that are in axially spaced apart relation for closing respective portions of the flow path when the valve members 216 sealingly engage the valve seats 230. The valve members 216 have individual freedom of movement along the longitudinal axis 219 between their respective open positions (FIG. 13) and their respective closed positions (FIG. 14).

As shown, the valve assembly 214 includes an actuator 220 which is constructed similarly to actuator 120, and thus operates with similar functionality. For example, the actuator 220 is movable in a direction of the longitudinal axis 219 in response to fluid pressure in the upstream (inlet) portion of the internal chamber 228 in the valve body 218. The actuator 220 is constructed as a piston assembly 220 having a hollow shaft portion 238 and a piston portion 240. An ambient pressure cavity 244 is formed on an opposite side of the piston portion 240, which is in fluid communication with the ambient environment surrounding the valve assembly 214 via vent fluid passages 248. The pressure differential between the fluid pressure in the upstream portion of chamber 228 and the ambient pressure in ambient cavity 244 provides a motive force to activate the actuator 220. As shown, the valve assembly 214 also includes a flow restrictor 222 downstream of the poppets 216 and upstream of the outlet 226. The flow restrictor 222 provided at the downstream portion of the valve 214 restricts fluid flow and facilitates a build-up and maintenance of the upstream pressure for facilitating activation of the actuator 220 in a similar manner as discussed above with respect to valve assembly 114.

Referring to FIG. 13, for example, the actuator 220 is activated in response to the fluid pressure in the upstream (inlet) portion of the internal chamber 228 being above a threshold value, which such activation causes the actuator 220 to commonly move the respective valve members 216 (directly or indirectly) to their respective open positions. The predefined pressure threshold for activating the actuator 220 may be set, at least in part, by the biasing forces provided by respective biasing members 234a, 234b, 234c which urge the corresponding valve members 216 (e.g., poppets) toward closed, and by the biasing force provided by an actuator biasing member 243 that biases the actuator 220 towards closed. In a similar manner as described above, when the inlet manifold pressure is at or above the predefined threshold, the actuator 220 (e.g., piston assembly) generates a sufficient force to overcome the biasing forces of the various biasing members 234, 243 and drive the valve members 216 toward their fully open positions. For example, in the illustrated embodiment, a downstream axial end portion 241 of the piston assembly 220 engages and moves the third poppet 216c, which in turn engages and moves the second poppet 216b via a poppet stem portion 270c, which such movement of the second poppet 216b in turn engages and moves the first poppet 216a via a poppet stem portion 270b. In exemplary embodiments, the stem portions 270 are unitary with respect to the sealing head portions of the poppets 216. As shown, the valve assembly 214 includes respective stops that restrict movement of the respective poppets 216 toward the outlet 226, such as stop surface 236 and the prevailing position of the other poppets 216.

Referring to the exemplary closed state of FIG. 14, when the pressure level in the upstream (inlet) portion of the chamber 228 is below the predefined threshold pressure level, the serially arranged poppets 216 are biased toward closed by their respective biasing members 234. In this state, the biasing forces provided by the biasing members 234, 243 are greater than the force provided by the actuator 220 by virtue of the upstream (inlet) pressure being below the threshold value, such as when the system or manifold pressure is reduced or non-operational. As shown in the illustrated state, each of the respective poppets 216a, 216b, 216c are biased by their respective biasing members 234a, 234b, 234c to sealingly engage their respective valve seats 230a, 230b, 230c and thus close respective portions of the flow path. The piston assembly 220 in the illustrated state is urged by the piston biasing member 243 toward the inlet 224 and stopped by surface 245. In the illustrated embodiment, the valve members 216 (e.g., poppets) and/or the biasing members 234 (e.g., springs) may be similar or identical to each other, which reduces differences in part assembly.

Similar to the valve assembly 114, the actuator 220 of valve assembly 214 may be discrete and independently movable relative to each valve member 216, and each valve member 216a, 216b, 216c is discrete and independently movable relative to each other. As shown in FIG. 14, for example, a gap 250 is formed between the first poppet 216a and stem portion 270b of second poppet 216b; another gap 252 is formed between the second poppet 216b and stem portion 270c of third poppet 216c; and yet another gap 254 is formed between the third poppet 216c and the end portion 241 of the piston assembly 220. In this manner, the poppets 216 are physically isolated from one another, and from the piston assembly 220, and thus function independently.

Similar to the valve assembly 114, the valve assembly 214 can tolerate any combination of failures of poppets 216a, 216b, 21c; biasing members 234a, 234b, 234c; and/or O-rings 268a, 268b, 268c and continue to provide reverse flow protection for as long as at least one set of reverse flow barriers remains functional. As shown, the valve assembly 214 also includes test ports 261, 262, and 263 which allow the reverse flow barriers to be individually vacuum leak tested similar to the valve assembly 114.

Exemplary valve assemblies, such as a pressure-operated check valve assemblies for a fuel tank inerting system, have been described herein. The valve assembly generally includes a valve body having a fluid flow path between an inlet and an outlet, a plurality of valve members (e.g., poppets) arranged in series in the fluid flow path, and an actuator (e.g., piston assembly) in the valve body that is movable in response to fluid pressure in the valve body to actuate open the poppets or enable the poppets to close. Each poppet may be movable in the flow path independent of the other poppets to thereby provide independent and redundant functionality. The poppets may be normally biased toward closed, and activation of the actuator in response to fluid pressure being greater than a predefined threshold level may cause the actuator to overcome the biasing force of the poppets to urge the poppets to open. A flow restrictor may be provided downstream of the poppets to facilitate buildup of upstream pressure and thereby facilitate low cracking pressure of the valve assembly.

The valve assembly (e.g., pressure-operated check valve assembly) disclosed herein may provide one or more of the following advantages:

The check valve assembly disclosed herein may use a pressure-operated piston to actuate open and firmly hold open all three poppets whenever the system pressure at or above the minimum threshold is available. The check valve may be generally impervious to the effects of any fluid flow perturbance. Provided there is a minimum required manifold pressure, the valve assembly may remain fully open and operate without chatter, flutter, or any other mechanical characteristics of dynamic instability.

The check valve assembly may use a plurality of independently operating check elements (e.g., valve members or poppets) providing serially redundant barriers against reverse flow. In the illustrated embodiments, the check valve design employs three serial-poppets (nested or un-nested) providing three redundant reverse flow barriers packaged into a small space. There generally is no limit on the maximum number of barriers which can be packaged into one valve assembly, as long as it meets the physical size allotment. A benefit of employing multiple reverse flow barriers is improved performance and reliability in preventing reverse flow and tolerance to multiple failures.

Increasing the number of reverse flow barriers employed by the exemplary check valve may allow an increased latency interval to be applied during operational analysis and correspondingly reduce the required frequency between periodic maintenance tests to be performed on the valve. The reduced frequency between tests reduces the maintenance cost.

In exemplary embodiments, the check valve may incorporate a series of poppet check elements and a flow control orifice which is disposed serially downstream of the check elements. In this manner, if any flow resistance is created by the check elements, they will not be added to the flow resistance of the NEA distribution system (downstream of the orifice). Generally, it is advantageous to have a distribution system of low flow resistance, as such would make it easier to achieve and maintain the desirable flow rate and flow balance in the various branches in the system.

Another advantage to having the flow control orifice placed downstream of the check valves is that any external leakage downstream of the orifice, including those from the check valves and/or ducting, will remain latent until they are physically examined during periodic ground maintenance checks. However, any external leakage occurring upstream of the flow control orifice will be detectable while the fuel tank inerting system is in operation by an onboard pressure sensor, for example. Any drop in the manifold pressure that is below normal levels would be detected and recognized as an external leakage.

Generally, the exemplary check valve(s) described herein can provide at least similar or equivalent functionality to multiple separate check valves as conventionally used, but integrated into a single valve to yield a light weight, small-size, and potentially lower cost alternative.

It is understood that other variations in the exemplary valve assembly design, including those design concepts based on flapper check elements instead of the nested or un-nested poppets shown, or those having a greater or reduced number of check elements than shown, can equally be employed without departing from the scope and spirit of the invention.

According to an aspect of the present disclosure, a valve includes: a valve housing having an inlet, an outlet, a valve seat, and a series of spring-loaded poppets movable along a longitudinal axis of the valve, wherein the series of spring-loaded poppets comprises: a first poppet that is biased by a first poppet spring toward the valve seat wherein its movement toward the outlet port is restricted by a stop formed in the housing, a second poppet nested inside the first poppet and is biased by a second poppet spring toward the valve seat and its movement toward the outlet port is restricted by the prevailing position of the first poppet, and a third poppet nested inside the second poppet and biased by a third poppet spring toward the valve seat and its movement toward the outlet port is restricted by the prevailing position of the second poppet.

Embodiments may include one or more of the following additional features, separately or in any combination.

In some embodiments, the valve further includes an internal space defined by the valve body on an upstream side of the valve seat, and a piston assembly disposed in the internal space having a piston that is movable along the longitudinal axis and which is biased toward the inlet port by a piston spring.

In some embodiments, the piston assembly is restricted in its movement toward the inlet port by a stop formed in the inlet fitting and toward the outlet fitting by the prevailing position of the third poppet.

In some embodiments, the piston assembly comprises a piston portion and a shaft portion adapted to operate slidably inside a center bore of an insert that defines the valve seat.

In some embodiments, the valve assembly further includes a flow control orifice upstream of the outlet port.

According to an aspect of the present disclosure, a pressure-operated check valve is provided that includes a pressure-operated actuator that responds to fluid pressure in the valve to actuate open one or more valve members in the valve to thereby allow flow through the valve, or in which the actuator responds to fluid pressure in the valve to enable the one or more valve members to close the fluid flow path through the valve.

According to another aspect of the present disclosure, a valve assembly includes: a valve body extending along a longitudinal axis, the valve body having an inlet, an outlet, and a fluid flow path fluidly connecting the inlet and outlet; a plurality of valve members arranged in series in the fluid flow path along the longitudinal axis, each of the plurality of valve members being axially movable within the fluid flow path between a respective open position in which the fluid flow path from the inlet to the outlet is open by the respective valve member, and a respective closed position in which the fluid flow path from the inlet to the outlet is closed by the respective valve member; and an actuator movable in a direction of the longitudinal axis in response to a fluid pressure level in the valve body; wherein activation or movement of the actuator to a first position in response to the fluid pressure level causes the actuator to move the respective valve members to their respective open positions to thereby open the fluid flow path through the valve body; and wherein deactivation or movement of the actuator to a second position in response to the fluid pressure level enables the respective valve members to move to their respective closed positions to thereby close the fluid flow path through the valve body.

According to another aspect of the present disclosure, a pressure-operated check valve assembly, includes: a valve housing having an inlet, an outlet, and a fluid flow path fluidly connecting the inlet and the outlet; a spring-loaded poppet in the valve housing arranged downstream of a valve seat portion in the fluid flow path, the spring-loaded poppet being independently movable along a longitudinal axis of the check valve assembly; a piston assembly slidably movable in the valve housing in a direction of the longitudinal axis, the piston assembly having a face exposed to upstream fluid pressure in an upstream chamber of the valve housing that is upstream of the valve seat portion; and a flow restrictor downstream of the valve seat portion; wherein the spring-loaded poppet includes a poppet that is biased by a poppet spring toward the valve seat portion; wherein, when a fluid pressure level in the upstream chamber of the valve housing is greater than a predefined threshold pressure level, the piston assembly moves in a direction toward the outlet thereby unseating the spring-loaded poppet from the valve seat portion and opening the fluid flow path between the inlet and the outlet; wherein, when the fluid pressure level in the upstream chamber of the valve housing is below the predefined threshold pressure level, the piston assembly moves in a direction toward the inlet and the spring-loaded poppet is seated against the valve seat portion thereby closing the fluid flow path between the inlet and the outlet; and wherein the predefined threshold pressure level is set at least in part by the biasing force provided by the poppet spring.

According to another aspect of the present disclosure, a pressure-operated check valve assembly, comprising: a valve housing having an inlet, an outlet, and a fluid flow path fluidly connecting the inlet and the outlet; a series of spring-loaded poppets in the valve housing arranged downstream of respective valve seat portions in the fluid flow path, the spring-loaded poppets being independently movable along a longitudinal axis of the check valve assembly; a piston assembly slidably movable in the valve housing in a direction of the longitudinal axis, the piston assembly having a face exposed to upstream fluid pressure in an upstream chamber of the valve housing that is upstream of the respective valve seat portions; and a flow restrictor downstream of the respective valve seat portions; wherein the series of spring-loaded poppets include at least a first poppet that is biased by a first poppet spring toward a respective first valve seat portion, and a second poppet that is biased by a second poppet spring toward a respective second valve seat portion; wherein, when a fluid pressure level in the upstream chamber of the valve housing is greater than a predefined threshold pressure level, the piston assembly moves in a direction toward the outlet thereby unseating each of the spring-loaded poppets from the respective valve seat portions and opening the fluid flow path from the inlet to the outlet; wherein, when the fluid pressure level in the upstream chamber of the valve housing is below the predefined threshold pressure level, the piston assembly moves in a direction toward the inlet and each of the spring-loaded poppets are seated against the respective valve seat portions thereby closing the fluid flow path from the inlet to the outlet; and wherein the predefined threshold pressure level is set at least in part by the combined biasing forces provided by the respective poppet springs.

Embodiment(s) according to the present disclosure may include one or more features of the foregoing aspects, separately or in any combination, which may be combined with one or more of the following additional features, which may be included separately or in any combination.

In some embodiments, the valve assembly further includes a flow restrictor downstream of the plurality of valve members.

In some embodiments, the actuator is upstream of the plurality of valve members and downstream of the inlet.

In some embodiments, wherein the actuator is configured to activate in response to the fluid pressure level in the valve being greater than a predefined threshold pressure level to thereby move to a first position and actuate the plurality of valve members to their respective open positions.

In some embodiments, the plurality of valve members are each normally biased toward their respective closed positions such that, when the pressure level in the valve is below the predefined threshold pressure level, the actuator is deactivated to thereby move to a second position and the valve members are biased to their respective closed positions.

In some embodiments, each of the plurality of valve members is discrete and independently movable relative to one another.

In some embodiments, the actuator is discrete and independently movable relative to each of the plurality of valve members.

In some embodiments, the flow restrictor enables fluid pressure to build-up upstream of actuator and downstream of inlet, and wherein the actuator is movable in response to a pressure differential on opposite sides of a portion of the actuator.

In some embodiments, the actuator is formed as a piston assembly having a piston portion that is slidably movable in a bore of the valve body, the piston portion having a face exposed to fluid pressure in an upstream portion of the valve body that is upstream of a valve seat against which at least one of the valve members sealingly engages when in the closed position.

In some embodiments, the piston assembly further includes a stem portion operably coupled to the piston portion for common axial movement therewith, the stem portion having an internal cavity that fluidly connects the upstream portion of the valve body to a downstream portion of the valve body that is downstream of the valve seat when the plurality of valve members are in their respective open positions.

In some embodiments, valve body includes an ambient pressure cavity that is fluidly connected to an ambient environment outside of the valve assembly, and wherein the piston portion fluidly separates the upstream portion of the valve body on one side of the piston portion from the ambient pressure cavity on an opposite side of the piston portion.

In some embodiments, the valve assembly further includes an actuator biasing member that biases the actuator toward a closed state, and respective valve member biasing members for each of the valve members that bias the respective valve members toward their respective closed positions.

In some embodiments, the actuator is configured to activate in response to the fluid pressure level in the valve being greater than a predefined threshold pressure level to thereby move to a first position and actuate the plurality of valve members to their respective open positions, and when the pressure level in the valve is below the predefined threshold pressure level, the actuator is deactivated to thereby move to a second position such that the valve members are biased to their respective closed positions.

In some embodiments, the predefined pressure level is set at least in part by the combined biasing forces provided by the actuator biasing member and each of the valve member biasing members.

In some embodiments, the actuator includes a piston portion having a face exposed to fluid pressure in an upstream portion of the valve body, the face of the piston portion being sized to provide a force of the actuator in response to fluid pressure in the upstream portion that is greater than the combined biasing forces provided by the actuator biasing member and each of the valve member biasing members, thereby enabling the actuator to urge the valve members to their respective open positions.

In some embodiments, the flow restrictor is upstream of the outlet or downstream of the outlet.

In some embodiments, the plurality of valve members are serially nested together, such that a second valve member is nested within a larger first valve member, and a smaller third valve member is nested within the second valve member; and such that, when in their respective closed positions, respective sealing surfaces of the valve members are axially aligned with each other when sealingly engaging respective portions of a valve seat.

In some embodiments, the plurality of valve members are axially spaced apart from each other along the longitudinal axis, and wherein respective valve seats corresponding with each valve member are axially spaced apart from each other along the longitudinal axis.

In some embodiments, each of the plurality of valve members is a poppet that provides a respective reverse flow barrier within the valve body.

In some embodiments, the valve assembly further includes a piston spring that biases the piston assembly toward the inlet.

In some embodiments, the predefined threshold pressure level is set at least in part by the combined biasing forces provided by the poppet spring and the piston spring.

In some embodiments, the valve housing includes an ambient pressure cavity that is fluidly connected to an ambient environment outside of the check valve assembly, and wherein the piston portion fluidly separates the upstream chamber on one side of the piston portion from the ambient pressure cavity on an opposite side of the piston portion.

According to another aspect of the present disclosure, a fuel tank inerting system includes: a fuel tank and a fluid circuit for distributing an inert gas to the fuel tank; and the valve assembly according to any of the foregoing aspects or embodiments fluidly connected in the fluid circuit.

As used herein, an “operable connection,” or a connection by which entities are “operably connected,” is one in which the entities are connected in such a way that the entities may perform as intended. An operable connection may be a direct connection or an indirect connection in which an intermediate entity or entities cooperate or otherwise are part of the connection or are in between the operably connected entities. An operable connection or coupling may include the entities being integral and unitary with each other.

It is understood that terms such as “top,” “bottom,” “upper,” “lower,” “left,” “right,” “front,” “rear,” “forward,” “rearward,” and the like as used herein may refer to an arbitrary frame of reference, rather than to the ordinary gravitational frame of reference.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A valve assembly comprising:
a valve body extending along a longitudinal axis, the valve body having an inlet, an outlet, and a fluid flow path fluidly connecting the inlet and outlet;
a plurality of valve members arranged in series in the fluid flow path along the longitudinal axis, each of the plurality of valve members being axially movable within the fluid flow path between a respective open position in which the fluid flow path from the inlet to the outlet is open by the respective valve member, and a respective closed position in which the fluid flow path from the inlet to the outlet is closed by the respective valve member; and
an actuator movable in a direction of the longitudinal axis in response to a fluid pressure level in the valve body;
wherein activation of the actuator in response to the fluid pressure level causes the actuator to move the respective valve members to their respective open positions to thereby open the fluid flow path through the valve body; and
wherein deactivation of the actuator in response to the fluid pressure level enables the respective valve members to move to their respective closed positions to thereby close the fluid flow path through the valve body.

2. The valve assembly according to claim 1, further comprising a flow restrictor downstream of the plurality of valve members.

3. The valve assembly according to claim 1,
wherein the actuator is upstream of the plurality of valve members and downstream of the inlet.

4. The valve assembly according to claim 1,
wherein the actuator is configured to activate in response to the fluid pressure level in the valve being greater than a predefined threshold pressure level to thereby move to a first position and actuate the plurality of valve members to their respective open positions, and
wherein the plurality of valve members are each normally biased toward their respective closed positions such that, when the pressure level in the valve is below the predefined threshold pressure level, the actuator is deactivated to thereby move to a second position and the valve members are biased to their respective closed positions.

5. The valve assembly according to claim 1,
wherein each of the plurality of valve members is discrete and independently movable relative to one another.

6. The valve assembly according to claim 1,
wherein the actuator is discrete and independently movable relative to each of the plurality of valve members.

7. The valve assembly according to claim 2,
wherein the flow restrictor enables fluid pressure to build-up upstream of actuator and downstream of inlet, and wherein the actuator is movable in response to a pressure differential on opposite sides of a portion of the actuator.

8. The valve assembly according to claim 1,
wherein the actuator is formed as a piston assembly having a piston portion that is slidably movable in a bore of the valve body, the piston portion having a face exposed to fluid pressure in an upstream portion of the valve body that is upstream of a valve seat against which at least one of the valve members sealingly engages when in the closed position.

9. The valve assembly according to claim 8,
wherein the piston assembly further includes a stem portion operably coupled to the piston portion for common axial movement therewith, the stem portion having an internal cavity that fluidly connects the upstream portion of the valve body to a downstream portion of the valve body that is downstream of the valve seat when the plurality of valve members are in their respective open positions.

10. The valve assembly according to claim 8,
wherein valve body includes an ambient pressure cavity that is fluidly connected to an ambient environment outside of the valve assembly, and wherein the piston portion fluidly separates the upstream portion of the valve body on one side of the piston portion from the ambient pressure cavity on an opposite side of the piston portion.

11. The valve assembly according to claim 1, further comprising an actuator biasing member that biases the actuator toward a closed state, and respective valve member biasing members for each of the valve members that bias the respective valve members toward their respective closed positions;
wherein the actuator is configured to activate in response to the fluid pressure level in the valve being greater than a predefined threshold pressure level to thereby move to a first position and actuate the plurality of valve members to their respective open positions, and when the pressure level in the valve is below the predefined threshold pressure level, the actuator is deactivated to thereby move to a second position such that the valve members are biased to their respective closed positions; and
wherein the predefined pressure level is set at least in part by the combined biasing forces provided by the actuator biasing member and each of the valve member biasing members.

12. The valve assembly according to claim 11,
wherein the actuator includes a piston portion having a face exposed to fluid pressure in an upstream portion of the valve body, the face of the piston portion being sized to provide a force of the actuator in response to fluid pressure in the upstream portion that is greater than the combined biasing forces provided by the actuator biasing member and each of the valve member biasing members, thereby enabling the actuator to urge the valve members to their respective open positions.

13. The valve assembly according to claim 2, wherein flow restrictor is upstream of the outlet or downstream of the outlet.

14. The valve assembly according to claim 1,
wherein the plurality of valve members are serially nested together, such that a second valve member is nested within a larger first valve member, and a smaller third valve member is nested within the second valve member; and such that, when in their respective closed positions, respective sealing surfaces of the valve members are axially aligned with each other when sealingly engaging respective portions of a valve seat.

15. The valve assembly according to claim 1,
wherein the plurality of valve members are axially spaced apart from each other along the longitudinal axis, and wherein respective valve seats corresponding with each valve member are axially spaced apart from each other along the longitudinal axis.

16. The valve assembly according to claim 1, wherein each of the plurality of valve members is a poppet that provides a respective reverse flow barrier within the valve body.

17. A pressure-operated check valve assembly, comprising:
a valve housing having an inlet, an outlet, and a fluid flow path fluidly connecting the inlet and the outlet;
a spring-loaded poppet in the valve housing arranged downstream of a valve seat portion in the fluid flow path, the spring-loaded poppet being independently movable along a longitudinal axis of the check valve assembly;
a piston assembly slidably movable in the valve housing in a direction of the longitudinal axis, the piston assembly having a face exposed to upstream fluid pressure in an upstream chamber of the valve housing that is upstream of the valve seat portion; and
a flow restrictor downstream of the valve seat portion;
wherein the spring-loaded poppet includes a poppet that is biased by a poppet spring toward the valve seat portion;
wherein, when a fluid pressure level in the upstream chamber of the valve housing is greater than a predefined threshold pressure level, the piston assembly moves in a direction toward the outlet thereby unseating the spring-loaded poppet from the valve seat portion and opening the fluid flow path between the inlet and the outlet;
wherein, when the fluid pressure level in the upstream chamber of the valve housing is below the predefined threshold pressure level, the piston assembly moves in a direction toward the inlet and the spring-loaded poppet is seated against the valve seat portion thereby closing the fluid flow path between the inlet and the outlet; and
wherein the predefined threshold pressure level is set at least in part by the biasing force provided by the poppet spring.

18. The pressure-operated check valve assembly according to claim 17, further comprising a piston spring that biases the piston assembly toward the inlet; and
wherein the predefined threshold pressure level is set at least in part by the combined biasing forces provided by the poppet spring and the piston spring.

19. The pressure-operated check valve assembly according to claim 17, wherein valve housing includes an ambient pressure cavity that is fluidly connected to an ambient environment outside of the check valve assembly, and wherein the piston portion fluidly separates the upstream chamber on one side of the piston portion from the ambient pressure cavity on an opposite side of the piston portion.

20. A fuel tank inerting system comprising:
a fuel tank and a fluid circuit for distributing an inert gas to the fuel tank; and
the valve assembly according to claim 1 fluidly connected in the fluid circuit.
